(19) United States
(12) Patent Application Publication
(10) Pub. No.: US 2025/0293390 A1
(43) Pub. Date: Sep. 18, 2025

(54) ENERGY STORAGE SYSTEM

(71) Applicant: Samsung SDI Co., Ltd., Yongin-si (KR)

(72) Inventors: In Hyeok SONG, Yongin-si (KR); Seung Han YOON, Yongin-si (KR); Dong Seok IN, Yongin-si (KR)

(21) Appl. No.: 18/741,468

(22) Filed: Jun. 12, 2024

(30) Foreign Application Priority Data
Mar. 14, 2024 (KR) 10-2024-0035711

(51) Int. Cl. H01M 50/383; A62C 3/16; A62C 37/08; H01M 50/204; H01M 50/673

(52) U.S. Cl. CPC H01M 50/383; A62C 3/16; A62C 37/08; H01M 50/204; H01M 50/673

(57) ABSTRACT

An energy storage system includes: a battery rack including a rack frame and a plurality of battery modules accommodated in the rack frame; a main pipe in the battery rack; and a fire extinguishing agent tank and sensor selectively connected to the main pipe. When the sensor and the main pipe are connected together, the sensor is configured to sense an event in the battery rack by sucking air from the main pipe.

### CROSS-REFERENCE TO THE RELATED APPLICATION

The present application claims priority to and the benefit of Korean Patent Application No. 10-2024-0035711, filed on Mar. 14, 2024, in the Korean Intellectual Property Office, the entire disclosure of which is incorporated herein by reference.

### BACKGROUND

### 1. Field

Aspects of embodiments relate to an energy storage system.

### 2. Description of the Related Art

A secondary battery is a power storage system capable of storing electrical energy as chemical energy. A secondary battery is a battery that is designed to be charged and discharged, different from a primary battery, which is not designed to be charged. The secondary battery is used in IT devices, such as smartphones, cellular phones, laptops, or tablet PCs. In recent years, there has been a growing interest in electric vehicles to reduce environmental pollution. Accordingly, the secondary battery is also used in electric vehicles, which demand characteristics, such as high density, high power, and stability.

The information disclosed in this section is provided only for enhancement of understanding of the background of the disclosure and therefore it may contain information that does not form the prior art.

### SUMMARY

Embodiments of the present disclosure provide an energy storage system.

The energy storage system, according to an embodiment of the present disclosure, includes a battery rack including a rack frame and a plurality of battery modules accommodated in the rack frame; a main pipe in the battery rack; and a fire extinguishing agent tank and sensor selectively connected to the main pipe. When the sensor and the main pipe are connected together, the sensor is configured to sense an event in the battery rack by sucking air from the main pipe.

Each of the battery modules may include a fire extinguishing pipe, and the main pipe may be connected to each of the fire extinguishing pipes such that air sucked from an end of the fire extinguishing pipes passes to the main pipe.

Each of the battery modules may further include a plurality of battery cells, and the fire extinguishing pipe may extend along one side of the plurality of battery cells.

The energy storage system may further include a one-way valve coupled to an end of each of the fire extinguishing pipes.

The one-way valves may include check valves.

The one-way valves may include a first body, a second body, and an opening/closing plate, the first body may be connected to an end of the fire extinguishing pipe, the second body may be opposite to the first body, and the opening/closing plate may be arranged in a groove between the first body and the second body.

The opening/closing plate may be configured to move in one direction corresponding to the direction of a fluid incident thereon.

When air passes from the outside of the second body to the one-way valve, the opening/closing plate may move toward the first body to expose the groove.

When air moves from the second body toward the first body, the air may pass to the sensor through the fire extinguishing pipe and the main pipe.

When an event is sensed by the sensor, the opening/closing plate may move toward the first body such that the groove is closed by the opening/closing plate.

A fire extinguishing agent may be configured to be delivered from the fire extinguishing agent tank to the fire extinguishing pipe through the main pipe.

The fire extinguishing agent may not move to the second body due to the opening/closing plate.

The fire extinguishing pipe may include a pipe member and a seal member, the pipe member may extend along the battery cells, and the sealing member may be at a position corresponding to at least one of the battery cells.

The pipe member may include a fire extinguishing agent hole, the fire extinguishing agent hole may be at a position corresponding to the at least one of the battery cells, and the sealing member may seal the fire extinguishing agent hole.

The sealing member may have a groove, and a thickness of the sealing member at the groove may be thinner than other areas of the sealing member.

An energy storage system, according to an embodiment of the present disclosure, includes: a battery rack including a rack frame and a plurality of battery modules accommodated in the rack frame; a main pipe in the battery rack; a fire extinguishing agent tank and sensor selectively connected to the main pipe; a fire extinguishing pipe on at least one of the battery modules and connected to the main pipe; and a one-way valve coupled to an end of the fire extinguishing pipe. The one-way valve includes a first body, a second body, and an opening/closing plate, the first body connected to an end of the fire extinguishing pipe, the second body being opposite to the first body, the opening/closing plate being arranged in a groove between the first body and the second body. Smoke generated in the battery rack or a fire extinguishing agent supplied from the fire extinguishing agent tank is moved within the fire extinguishing pipe according to movement of the opening/closing plate.

When the smoke is at the end of the fire extinguishing pipe, the smoke may pass to the sensor through the fire extinguishing pipe and the main pipe, and when an event in the battery rack is sensed by the sensor, the fire extinguishing agent in the fire extinguishing agent tank may be delivered to the fire extinguishing pipe through the main pipe.

When smoke is received from the outside of the second body to the one-way valve, the opening/closing plate may move toward the first body such that the groove is exposed by the opening/closing plate, the smoke moves from the second body to the first body, and the smoke passes to the sensor through the fire extinguishing pipe and the main pipe.

When an event is sensed by the sensor, the opening/closing plate may move toward the first body such that the groove is closed by the opening/closing plate and the fire extinguishing agent does not pass to the second body due to the opening/closing plate.

The fire extinguishing pipe may include a pipe member and a seal member, the pipe member may have a fire extinguishing agent hole, the sealing member may be configured to be melted by an event, and the fire extinguishing agent hole may be exposed due to the melting of the sealing member.

### BRIEF DESCRIPTION OF THE DRAWINGS

The accompanying drawings, which are incorporated in this specification, illustrate preferred embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a schematic view of an energy storage system according to an embodiment.

FIG. 2 is an enlarged view of the region A in FIG. 1.

FIG. 3 is a plan view of a fire extinguishing pipe coupled to a rack frame.

FIG. 4a is a plan view of the fire extinguishing pipe shown in FIG. 3.

FIG. 4b is an enlarged view of the region B in FIG. 4a.

FIG. 4c is a schematic plan view of a fire extinguishing pipe to which a sealing member is coupled according to an embodiment.

FIG. 5a is a plan view of a one-way valve according to an embodiment.

FIGS. 5b and 5c are schematic cross-sectional views describing the operation of the one-way valve shown in FIG. 5a.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Hereinafter, embodiments of the present disclosure will be described, in detail, with reference to the drawings.

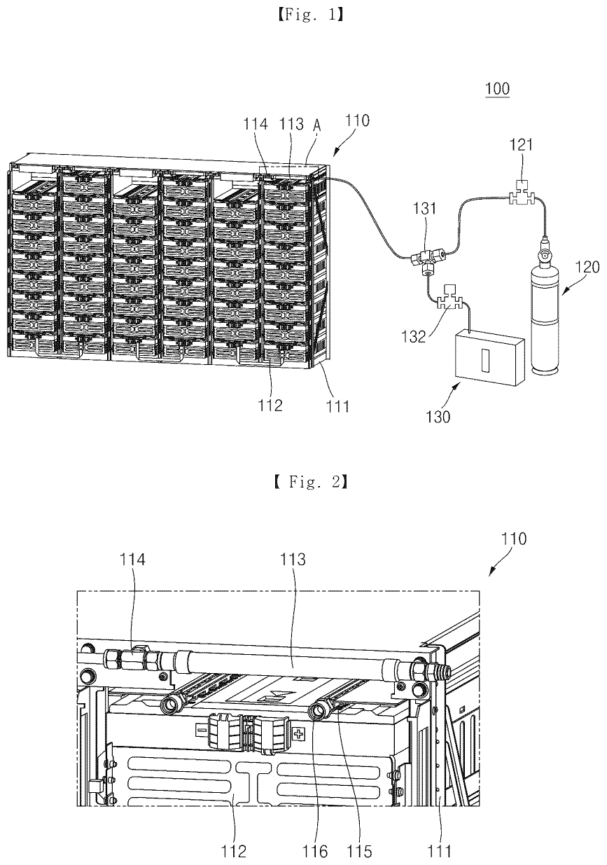

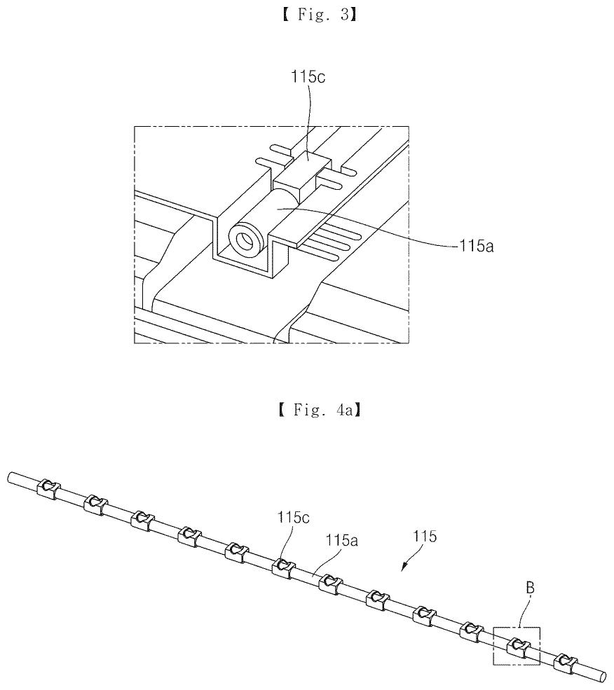

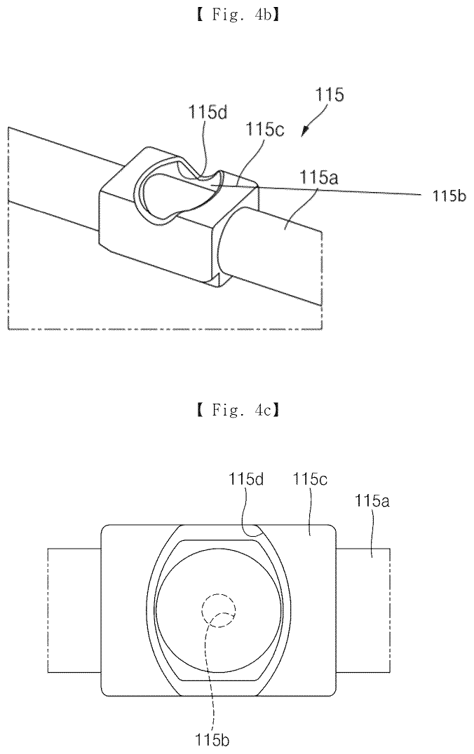

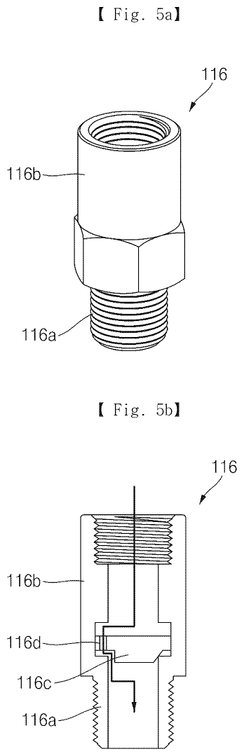

Referring to FIGS. 1 to 3, the energy storage system 100, according to an embodiment of the present disclosure, may include at least one battery rack 110, a fire extinguishing agent tank 120, and a sensor 130. The fire extinguishing agent tank 120 and the sensor 130 may be connected to the battery rack 110 through a fire extinguishing pipe.

Each battery rack 110 may include a rack frame 111 and a plurality of battery modules 112. The battery modules 112 may be accommodated in the rack frame 111.

The rack frame 111 may include (or may form) accommodation spaces divided at (or spaced apart at) regular intervals. A plurality of battery modules 112 may be accommodated in the rack frame 111. A circuit board may be coupled to the rear of the rack frame 111. The circuit board may include a module BMS (Battery Management System). Accordingly, the battery module 112 may be sensed (e.g., monitored) and controlled by the circuit board.

The battery module 112 may include a plurality of battery cells. The battery cells may be connected together in series, parallel, or series/parallel depending on the desired output. Each battery cell may include a case and an electrode assembly inside the case. The electrode assembly may include a positive electrode plate and a negative electrode plate, each of which have a coating portion on which an active material is coated. Also, a separator may be disposed between the positive electrode plate and the negative electrode plate. The electrode assembly may be formed by being wound, stacked, or laminated. The upper portion of the case may be sealed by a cap plate. The positive electrode plate and the negative electrode plate may each also have an uncoated portion. An electrode terminal may be electrically connected to the uncoated portion of at least one of the positive electrode plate and the negative electrode plate. The electrode terminal may be exposed to (or exposed above) the upper portion of the cap plate. Also, a vent may be formed in the center of the cap plate. The vent may be formed to be thinner than other areas of the cap plate. When the internal pressure of the battery cell rises above a reference pressure, the vent may be opened (e.g., the vent may burst). Accordingly, gas may be released to the outside. Therefore, the battery cell may be prevented from exploding.

The battery modules 112 may also be connected together in series, parallel, or series/parallel, respectively. Accordingly, the battery rack 110 may generate a desired output (e.g., a desired electrical output).

A main pipe 113 may be formed in each battery rack 110. The main pipe 113 may be formed in a partial area of the battery rack 110. For example, the main pipe 113 may be disposed at (or on) an upper portion of the battery rack 110 and may extend in a longitudinal direction of the battery rack 110. The main pipe 113 may be connected to fire extinguishing pipes 115. One fire extinguishing pipe 115 may be formed in each battery module 112. The fire extinguishing pipe 115 may be formed along one side of the plurality of battery cells. A one-way valve 116 may be coupled to one end of the fire extinguishing pipe 115. The one-way valve 116 may be configured to move fluid (or to allow fluid to move) in only one direction. Accordingly, the battery module 112 may suck air into the fire extinguishing pipe 115 during normal operation. The air sucked into the fire extinguishing pipe 115 of each battery module 112 may be collected in the main pipe 113. Additionally, the main pipe 113 may be connected to the sensor 130. The sensor 130 may sense (e.g., may determine the presence of) smoke by sucking air (or by monitor air sucked) from the battery rack 110.

When an event, such as a fire, occurs in the battery rack 110, the main pipe 113 may be filled with a fire extinguishing agent. The main pipe 113 may be connected to the fire extinguishing agent tank 120. Accordingly, the fire extinguishing agent may be delivered to the fire extinguishing pipe 115. Accordingly, the fire extinguishing agent may be appropriately sprayed to a specific battery cell(s) of the battery module 112 where the event is occurring.

The main pipe 113 may include a main pipe valve 114 corresponding to each battery rack 110. The main pipe valve 114 may include (or may be) a solenoid valve. The main pipe valve 114 may be formed on each connection part of each battery rack 110. The main pipe valve 114 may be open during normal operation. Accordingly, the air sucked from the fire extinguishing pipe 115 of each battery rack 110 may be delivered to the sensor 130 through the main pipe 113.

When an event occurs, the fire extinguishing agent may be delivered only to the battery rack 110 at where the fire is occurring (or occurred) by the main pipe valve 114. The fire extinguishing agent may not be delivered to the battery rack 110 where a fire has not occurred due to the main pipe valve 114. Therefore, the fire extinguishing agent is delivered only to the battery rack 110 where the event occurred. Accordingly, the fire extinguishing agent may quickly fill the fire extinguishing pipe 115 of the battery rack 110 where the event occurred.

The fire extinguishing pipe 115 may be formed on each battery module 112 of each battery rack 110. The fire extinguishing pipe 115 may be coupled to the main pipe 113. As described above, the one-way valve 116 may be coupled to the end of each fire extinguishing pipe 115. Accordingly, air may be sucked only in a direction from the battery rack 110 toward the inside of the fire extinguishing pipe 115. Also, when an event occurs, the fire extinguishing agent may be sprayed toward the battery cell without leaking out of the fire extinguishing pipe 115.

The fire extinguishing pipe 115 may include a pipe member 115a and a sealing member 115c. The sealing member 115c may be coupled to a setting area of the pipe member 115a.

The pipe member 115a may have a fire extinguishing agent hole (e.g., a fire extinguishing agent opening) 115b. A plurality of fire extinguishing agent holes 115b may be formed respectively at locations corresponding to each battery cell. The sealing member 115c may surround each fire extinguishing agent hole 115b. Accordingly, the air or fire extinguishing agent filled in the fire extinguishing pipe 115 may be prevented (or may be blocked) from being sucked in or sprayed through the fire extinguishing agent hole 115b during normal operation.

When an event occurs in a specific battery cell, the vent of the corresponding battery cell may open. Accordingly, high-temperature gas may be discharged to the outside of the battery cell. Heat generated by the gas may be transferred to the fire extinguishing pipe 115. Accordingly, the sealing member 115c, which is heated by the discharged high-temperature gas, may melt. Accordingly, the fire extinguishing agent hole 115b may be exposed due to the sealing member 115c melting. Accordingly, the fire extinguishing agent may be sprayed to (or toward) the battery cell in which the event is occurring or occurred through the fire extinguishing agent hole 115b. Therefore, the fire extinguishing agent may be sprayed only at a meaningful location (e.g., only at a location at where a battery cell experiencing an event is located). Because the fire extinguishing agent is concentrated and sprayed only at the meaningful location, the fire may be extinguished at an early stage (e.g., before it progresses).

For the above operation, the sealing member 115c may have a concave groove 115d. The groove 115d may correspond to the position at where the fire extinguishing agent hole 1115b is formed. The area of the sealing member 115c at where the groove 115d is formed may be thinner than other areas of the sealing member 115c. Accordingly, the sealing member 115c may be more easily melted at a reference temperature to expose the fire extinguishing agent hole 115b.

The fire extinguishing agent tank 120 may store a fire extinguishing agent. The fire extinguishing agent tank 120 may be connected to the main pipe 113 through a pipe. A tank valve 121 may be coupled to the inlet of the fire extinguishing agent tank 120. Accordingly, the fire extinguishing agent tank 120 may connect (e.g., fluidly connect) with the main pipe 113 only when an event occurs. For example, the tank valve 121 may include (or may be) a solenoid valve. The tank valve 121 is in a closed state during normal operation. Accordingly, the fire extinguishing agent tank 120 is not connected to the main pipe 113 during normal operation. When an event occurs, the tank valve 121 is opened. Accordingly, the fire extinguishing agent tank 120 may be connected to the main pipe. A separate pump may be further coupled to supply the fire extinguishing agent to the main pipe 113.

The sensor 130 is a device that is configured to sense (e.g., configured to monitor for) smoke by sucking air. For example, the sensor 130 may include a Very Early Smoke Detection Apparatus (VESDA) sensor. Whether an event has occurred in a battery cell of each battery rack 110 may be sensed in real time by the smoke sensed by the sensor 130.

The sensor 130 may be connected to the main pipe 113 through a pipe during normal operation. The sensor 130 may be separated from the fire extinguishing agent tank 120 and connected to the pipe through a branch pipe 131. For example, the sensor 130 and the fire extinguishing agent tank 120 may each be connected to the pipe through a branch pipe 131. However, the sensor 130 and the fire extinguishing agent tank 120 may be selectively connected to the branch pipe 131 through independently operated valves 132 and 121, respectively.

For example, the sensor valve 132 may normally be open (e.g., may be open during normal operation). The sensor 130 may be connected to the main pipe 113 through the sensor valve 132 during normal operation. Accordingly, the main pipe 113 may suck in air from the battery rack 110. Additionally, whether an event has occurred or not may be determined by the sensor 130. During normal operation, the tank valve 121 may be in a closed state. Accordingly, the fire extinguishing agent tank 120 may not be connected to the main pipe 113.

When an event occurs, the sensor valve 132 may be closed. Accordingly, the sensor 130 may not be connected to the main pipe 113. Also, the tank valve 121 may be opened. Accordingly, the fire extinguishing agent tank 120 may be connected to the main pipe 113. Accordingly, the fire extinguishing agent may be supplied to the main pipe 113 by the pipe.

The sensor 130 may be disposed outside the battery rack 110. Therefore, the sensor 130 is not affected by (or is not limited by) the space of the battery rack 110. Also, the sensor 130 may suck air through the main pipe 113 and the fire extinguishing pipe 115. Accordingly, the sensor 130 may be easily installed. Also, whether or not an event occurs in the battery rack 110 may be more quickly sensed (or determined).

Hereinafter, the one-way valve 116 will be described in more detail.

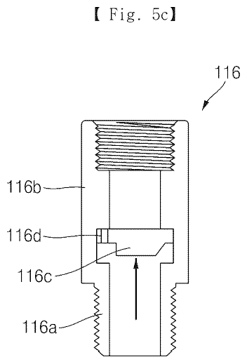

Referring to FIGS. 5a and 5b, the one-way valve 116 may be coupled to the end of the fire extinguishing pipe 115. The one-way valve 116 may be a check valve. The one-way valve 116 is a valve configured (or manufactured) so that fluid flows only in one (e.g., flows only in a predetermined) direction.

The one-way valve 116 may include a first body 116a, a second body 116b, and an opening/closing plate 116c. The first body 116a may be disposed at the end of the fire extinguishing pipe 115. The second body 116b may be disposed in a position opposite to the first body 116a. The opening/closing plate 116c may be located in a groove between the first body 116a and the second body 116b. The opening/closing plate 116c may open and close a fluid movement passage through the one-way valve 116. The opening/closing plate may move in one direction depending on the direction of the fluid (e.g., depending on the fluid pressure applied thereto).

Referring to FIG. 5b, during normal operation, negative pressure may be applied from the first body 116a. Accordingly, the opening/closing plate 116c may move in the direction of (e.g., may move toward) the first body 116a within the groove. In this case, air from the outside of the second body 116b may pass through the through hole 116d formed inside the opening/closing plate 116c. Accordingly, the air may be delivered to (e.g., may pass to) the first body 116a. For example, the air may flow through the one-way valve 116. Finally, the air may be delivered to the sensor 130 through the fire extinguishing pipe 115 and the main pipe 113. Therefore, during normal operation, smoke in the air may be sensed by the sensor 130. Accordingly, whether or not an event of the battery rack 110 occurs may be sensed.

Referring to FIG. 5c, when an event is sensed (or determined) to have occurred in the battery rack 110 by the sensor 130 or another sensing device, the fire extinguishing agent may be delivered to the main pipe 113 and the fire extinguishing pipe 115. The fire extinguishing agent may be supplied from the fire extinguishing agent tank 120. In this case, the opening/closing plate 116c may move in the direction of (e.g., may move toward) the second body 116b within the groove due to the pressure of the fire extinguishing agent. Accordingly, the through hole 116d may be closed by the opening/closing plate 116c. Therefore, the opening/closing plate 116c may close the flow path. Accordingly, the extinguishing agent inside the first body 116a may not be delivered to (e.g., may not pass to) the second body 116b. Therefore, the fire extinguishing agent may be located only inside the fire extinguishing pipe 115. Accordingly, the fire extinguishing agent may be sprayed into (or onto) the battery cell where the event occurred.

The energy storage system, according to an embodiment, may include the one-way valve. The one-way valve may be formed at (or may be connected at) the end of the fire pipe. When the energy storage system is operating normally, air in the battery rack may be sucked in through the one-way valve. Accordingly, whether or not an event of the battery cell is present may be sensed by the sensor. When an event occurs in the battery cell, the fire extinguishing agent in the fire extinguishing agent tank may be supplied to the fire extinguishing pipe. Accordingly, restrictions on the installation space of the sensor may be reduced. In addition, an event of a battery cell may be quickly sensed and fire extinguishing agents supplied thereto.

The above is only one embodiment for implementing a secondary battery according to the disclosure, the disclosure is not limited to the above embodiment, and there is a technical spirit of the disclosure to the extent that various modifications can be made by anyone having ordinary skill in the art to which the disclosure pertains without departing from the gist of the disclosure as claimed in the following claims.

What is claimed is:

1. An energy storage system comprising:
a battery rack comprising a rack frame and a plurality of battery modules accommodated in the rack frame;
a main pipe in the battery rack; and
a fire extinguishing agent tank and sensor selectively connected to the main pipe,
wherein, when the sensor and the main pipe are connected together, the sensor is configured to sense an event in the battery rack by sucking air from the main pipe.

2. The energy storage system as claimed in claim 1, wherein each of the battery modules comprises a fire extinguishing pipe, and
wherein the main pipe is connected to each of the fire extinguishing pipes such that air sucked from an end of the fire extinguishing pipes passes to the main pipe.

3. The energy storage system as claimed in claim 2, wherein each of the battery modules further comprises a plurality of battery cells, and
wherein the fire extinguishing pipe extends along one side of the plurality of battery cells.

4. The energy storage system as claimed in claim 2, further comprising a one-way valve coupled to an end of each of the fire extinguishing pipes.

5. The energy storage system as claimed in claim 4, wherein the one-way valves comprise check valves.

6. The energy storage system as claimed in claim 4, wherein the one-way valves comprise a first body, a second body, and an opening/closing plate,
wherein the first body is connected to an end of the fire extinguishing pipe,
wherein the second body is opposite to the first body, and
wherein the opening/closing plate is arranged in a groove between the first body and the second body.

7. The energy storage system as claimed in claim 6, wherein the opening/closing plate is configured to move in one direction corresponding to the direction of a fluid incident thereon.

8. The energy storage system as claimed in claim 6, wherein, when air passes from the outside of the second body to the one-way valve, the opening/closing plate moves toward the first body to expose the groove.

9. The energy storage system as claimed in claim 8, wherein when air moves from the second body toward the first body, the air passes to the sensor through the fire extinguishing pipe and the main pipe.

10. The energy storage system as claimed in claim 6, wherein, when an event is sensed by the sensor, the opening/closing plate moves toward the first body such that the groove is closed by the opening/closing plate.

11. The energy storage system as claimed in claim 10, wherein a fire extinguishing agent is configured to be delivered from the fire extinguishing agent tank to the fire extinguishing pipe through the main pipe.

12. The energy storage system as claimed in claim 11, wherein the fire extinguishing agent does not move to the second body due to the opening/closing plate.

13. The energy storage system as claimed in claim 2, wherein the fire extinguishing pipe comprises a pipe member and a seal member,
wherein the pipe member extends along the battery cells, and
wherein the sealing member is at a position corresponding to at least one of the battery cells.

14. The energy storage system as claimed in claim 13, wherein the pipe member comprises a fire extinguishing agent hole, and
wherein the fire extinguishing agent hole is at a position corresponding to the at least one of the battery cells, and the sealing member seals the fire extinguishing agent hole.

15. The energy storage system as claimed in claim 14, wherein the sealing member has a groove, and
wherein a thickness of the sealing member at the groove is thinner than other areas of the sealing member.

16. An energy storage system comprising:
a battery rack comprising a rack frame and a plurality of battery modules accommodated in the rack frame;
a main pipe in the battery rack;
a fire extinguishing agent tank and sensor selectively connected to the main pipe;
a fire extinguishing pipe on at least one of the battery modules and connected to the main pipe; and
a one-way valve coupled to an end of the fire extinguishing pipe, the one-way valve comprising a first body, a second body, and an opening/closing plate, the first body connected to an end of the fire extinguishing pipe, the second body being opposite to the first body, the opening/closing plate being arranged in a groove between the first body and the second body,
wherein smoke generated in the battery rack or a fire extinguishing agent supplied from the fire extinguishing agent tank is moved within the fire extinguishing pipe according to movement of the opening/closing plate.

17. The energy storage system as claimed in claim 16, wherein, when the smoke is at the end of the fire extinguishing pipe, the smoke passes to the sensor through the fire extinguishing pipe and the main pipe, and
wherein, when an event in the battery rack is sensed by the sensor, the fire extinguishing agent in the fire extinguishing agent tank is delivered to the fire extinguishing pipe through the main pipe.

18. The energy storage system as claimed in claim 16, wherein, when smoke is received from the outside of the second body to the one-way valve, the opening/closing plate moves toward the first body such that the groove is exposed by the opening/closing plate, the smoke moves from the second body to the first body, and the smoke passes to the sensor through the fire extinguishing pipe and the main pipe.

19. The energy storage system as claimed in claim 16, wherein, when an event is sensed by the sensor, the opening/closing plate moves toward the first body such that the groove is closed by the opening/closing plate and the fire extinguishing agent does not pass to the second body due to the opening/closing plate.

20. The energy storage system as claimed in claim 16, wherein the fire extinguishing pipe comprises a pipe member and a seal member,
wherein the pipe member has a fire extinguishing agent hole,
wherein the sealing member is configured to be melted by an event, and
wherein the fire extinguishing agent hole is exposed due to the melting of the sealing member.
